(19) United States
(12) Patent Application Publication
(10) Pub. No.: US 2009/0257043 A1
(43) Pub. Date: Oct. 15, 2009

(54) ILLUMINATION OPTICAL SYSTEM, EXPOSURE APPARATUS, DEVICE MANUFACTURING METHOD, AND EXPOSURE OPTICAL SYSTEM

(75) Inventors: Takashi MORI, Fujisawa-shi (JP); Hirohisa Tanaka, Kumagaya-shi (JP)

Correspondence Address: STAAS & HALSEY LLP, SUITE 700, 1201 NEW YORK AVENUE, N.W., WASHINGTON, DC, 20005, US

(73) Assignee: NIKON CORPORATION, Tokyo (JP)

(21) Appl. No.: 12/371,166

(22) Filed: Feb. 13, 2009

Related U.S. Application Data
(60) Provisional application No. 61/071,139, filed on Apr. 14, 2008.

(51) Int. Cl. G03B 27/72

(52) U.S. Cl. 355/71

(57) ABSTRACT

An illumination optical system to illuminate an illumination target surface with light from a light source comprises a distribution forming optical system including an optical integrator and forming a pupil intensity distribution on an illumination pupil located behind the optical integrator; and a transmission filter with a transmittance characteristic varying depending upon an angle of incidence of light, which is arranged in an illumination pupil space between an optical element with a power adjacent in front of the illumination pupil and an optical element with a power adjacent behind the illumination pupil and which is arranged at a position of incidence of light to pass through only a partial region of the illumination pupil or light having passed through only a partial region of the illumination pupil.

### CROSS-REFERENCE TO RELATED APPLICATIONS

This application is based upon and claims the benefit of priorities from U.S. Provisional Application No. 61/071,139, filed on Apr. 14, 2008, the entire contents of which are incorporated herein by reference.

### BACKGROUND OF THE INVENTION

### Field

Embodiments of the present invention relate to an illumination optical system, exposure apparatus, device manufacturing method, and exposure optical system.

### DESCRIPTION OF THE RELATED ART

In a typical exposure apparatus of this kind, light emitted from a light source travels through a fly's eye lens as an optical integrator to form a secondary light source (in general, a certain light intensity distribution on an illumination pupil) as a substantial surface illuminant consisting of a large number of light sources. The light intensity distribution on the illumination pupil will be referred to hereinafter as “pupil intensity distribution.” The illumination pupil is defined as follows: by action of an optical system between the illumination pupil and an illumination target surface (a mask or wafer in the case of exposure apparatus), the illumination target surface becomes a Fourier transform surface of the illumination pupil.

Light from the secondary light source is condensed by a condenser lens and then superposedly illuminates the mask on which a predetermined pattern is formed. Light transmitted by the mask travels through a projection optical system to be focused on the wafer, whereby the mask pattern is projected (or transferred) onto the wafer. Since the pattern formed on the mask is a highly integrated one, a uniform illuminance distribution can be formed on the wafer in order to accurately transfer this microscopic pattern onto the wafer.

U.S. Pat. Published Application No. 2006/0055834 suggests the technology of forming the pupil intensity distribution, for example, of an annular shape or a multi-polar shape (dipolar, quadrupolar, or other shape) to improve the depth of focus and the resolving power of the projection optical system, in order to accurately transfer the microscopic pattern of the mask onto the wafer.

### SUMMARY

An embodiment of the present invention provides an illumination optical system capable of independently adjusting each of pupil intensity distributions for respective points on an illumination target surface. Another embodiment of the present invention provides an exposure apparatus capable of performing excellent exposure under an appropriate illumination condition, using the illumination optical system configured to independently adjust each of pupil intensity distributions for respective points on an illumination target surface.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessary achieving other advantages as may be taught or suggested herein.

In order to solve the above problem, an embodiment of the present invention provides an illumination optical system which illuminates an illumination target surface with light from a light source, the illumination optical system comprising: a distribution forming optical system including an optical integrator and configured to form a pupil intensity distribution on an illumination pupil located behind the optical integrator; and a transmission filter with a transmittance characteristic varying depending upon an angle of incidence of light, which is arranged in an illumination pupil space between an optical element with a power adjacent in front of the illumination pupil and an optical element with a power adjacent behind the illumination pupil and which is arranged at a position of incidence of light to pass through only a partial region of the illumination pupil or light having passed through only a partial region of the illumination pupil.

Another embodiment of the present invention provides an exposure apparatus comprising the illumination optical system of the first aspect to illuminate a predetermined pattern, which performs exposure of the predetermined pattern on a photosensitive substrate.

Another embodiment of the present invention provides a device manufacturing method comprising: effecting the exposure of the predetermined pattern on the photosensitive substrate, using the exposure apparatus according to the above embodiment; developing the photosensitive substrate on which the predetermined pattern has been transferred, to form a mask layer in a shape corresponding to the predetermined pattern on a surface of the photosensitive substrate; and processing the surface of the photosensitive substrate through the mask layer.

Still another embodiment of the present invention provides an exposure optical system to perform exposure of an exposure target surface with light from a light source, the exposure optical system comprising: a distribution forming optical system including an optical integrator and configured to form a pupil intensity distribution on an illumination pupil located behind the optical integrator; and a transmission filter with a transmittance characteristic varying depending upon an angle of incidence of light, which is arranged in an illumination pupil space between an optical element with a power adjacent in front of the illumination pupil and an optical element with a power adjacent behind the illumination pupil or a space conjugate with the illumination pupil space and which is arranged at a position of incidence of light to pass through only a partial region of the illumination pupil or light having passed through only a partial region of the illumination pupil.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a drawing schematically showing a configuration of an exposure apparatus according to an embodiment of the present invention.

FIG. 2 is a drawing showing a secondary light source of a quadrupolar shape formed on the illumination pupil.

FIG. 3 is a drawing showing a still exposure region of a rectangular shape formed on a wafer.

FIG. 4 is a drawing to illustrate a property of a pupil intensity distribution of a quadrupolar shape formed by light incident to a center point P1 in the still exposure region.

FIG. 5 is a drawing to illustrate a property of a pupil intensity distribution of a quadrupolar shape formed by light incident to peripheral points P2, P3 in the still exposure region.

FIG. 6A is a drawing schematically showing a light intensity profile along the Z-direction of the pupil intensity distribution related to the center point P1.

FIG. 6B is a drawing schematically showing a light intensity profile along the Z-direction of the pupil intensity distribution related to the peripheral points P2, P3.

FIG. 7 is a first drawing to illustrate action of a second correction filter in the embodiment.

FIG. 8 is a second drawing to illustrate the action of the second correction filter in the embodiment.

FIG. 9 is a drawing showing a transmittance characteristic of the second correction filter in the embodiment.

FIG. 10 is a drawing schematically showing how the pupil intensity distribution related to the center point P1 is adjusted by the second correction filter.

FIG. 11 is a drawing schematically showing how the pupil intensity distribution related to the peripheral points P2, P3 is adjusted by the second correction filter.

FIG. 12 is a flowchart showing manufacturing blocks of semiconductor devices.

FIG. 13 is a flowchart showing manufacturing blocks of a liquid crystal device such as a liquid crystal display device.

FIG. 14 is a drawing schematically showing a configuration of a second correction filter according to a modification example of the embodiment.

FIG. 15 is a drawing schematically showing a configuration of an exposure optical system according to an embodiment.

FIG. 16 is a drawing schematically showing a configuration of an exposure optical system according to another embodiment.

### BEST MODES FOR CARRYING OUT THE INVENTION

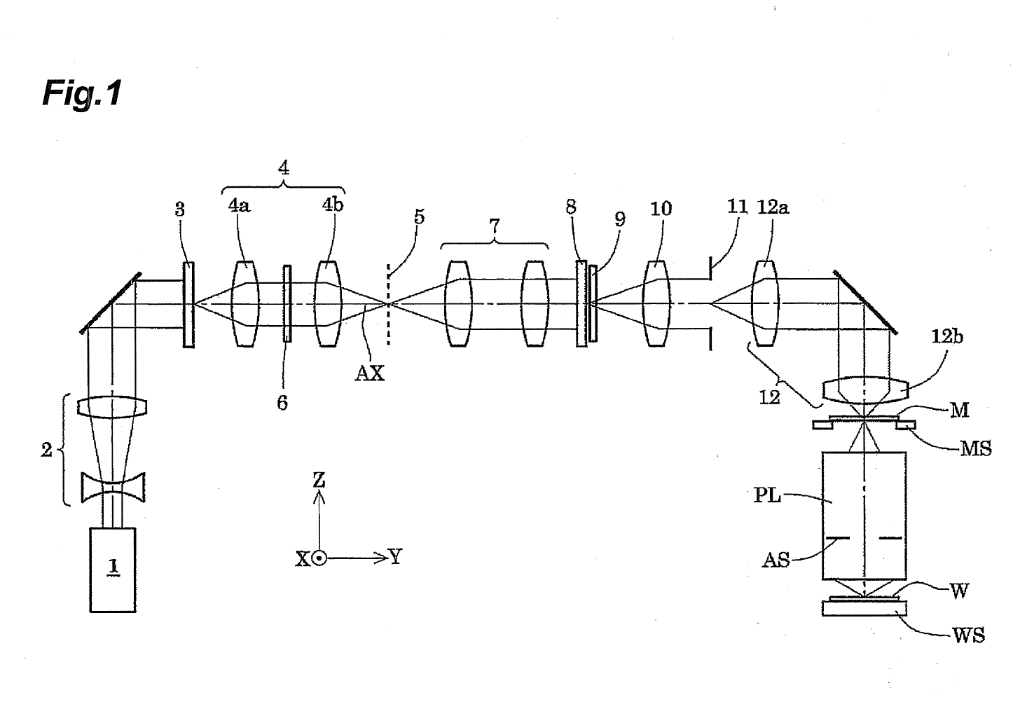

Embodiments of the present invention will be described on the basis of the accompanying drawings. FIG. 1 is a drawing schematically showing a configuration of an exposure apparatus according to an embodiment of the present invention. In FIG. 1, the Z-axis is set along a direction of a normal to an exposure surface (transfer surface) of a wafer W being a photosensitive substrate, the Y-axis along a direction parallel to the plane of FIG. 1 in the exposure surface of the wafer W, and the X-axis along a direction perpendicular to the plane of FIG. 1 in the exposure surface of the wafer W.

With reference to FIG. 1, exposure light (illumination light) is supplied from a light source 1 in the exposure apparatus of the present embodiment. The light source 1 can be, for example, an ArF excimer laser light source to supply light at the wavelength of 193 nm or a KrF excimer laser light source to supply light at the wavelength of 248 nm. The light beam emitted from the light source 1 is converted into a beam of a required sectional shape by a shaping optical system 2 and thereafter the shaped beam travels, for example, through a diffractive optical element 3 for annular illumination to enter an afocal lens 4.

The afocal lens 4 is an afocal system (afocal optic) which is so set that a front focal point thereof agrees approximately with the position of the diffractive optical element 3 and that a rear focal point thereof agrees approximately with a position of a predetermined plane 5 indicated by a dashed line in the drawing. The diffractive optical element 3 is made by forming level differences at the pitch nearly equal to the wavelength of the exposure light (illumination light) on a substrate and has an action to diffract an incident beam at desired angles. Specifically, the diffractive optical element 3 for annular illumination has such a function that when a parallel beam with a rectangular cross section is incident thereto, it forms a light intensity distribution of an annular shape in its far field (or Fraunhofer diffraction region).

Therefore, the nearly parallel beam incident to the diffractive optical element 3 forms a light intensity distribution of an annular shape on a pupil plane of the afocal lens 4 and thereafter it is emitted in an annular angle distribution from the afocal lens 4. In the optical path between front lens unit 4a and rear lens unit 4b of the afocal lens 4, there is a first correction filter 6 arranged at or near the pupil position. The first correction filter 6 has a form of a plane-parallel plate and a dense pattern of light-shielding dots of chromium, chromium oxide, or the like is formed on its optical surface. Namely, the first correction filter 6 has a transmittance distribution of different transmittances depending upon positions of incidence of light. A specific action of the first correction filter 6 will be described later.

The light having passed through the afocal lens 4 travels through a zoom lens 7 for varying the a value or coherence factor (σ value (coherence factor)=mask-side numerical aperture of the illumination optical system/mask-side numerical aperture of the projection optical system), to enter a micro fly's eye lens (or fly's eye lens) 8 as an optical integrator. The micro fly's eye lens 8 is, for example, an optical element consisting of a large number of micro lenses with a positive refracting power arrayed vertically and horizontally and densely, and is made by forming the micro lens group by etching of a plane-parallel plate.

Each micro lens forming the micro fly's eye lens is smaller than each lens element forming the fly's eye lens. In the micro fly's eye lens, different from the fly's eye lens consisting of lens elements isolated from each other, the large number of micro lenses (microscopic refracting faces) are integrally formed without being isolated from each other. However, the micro fly's eye lens is an optical integrator of the same wavefront division type as the fly's eye lens in that the lens elements with the positive refracting power are vertically and horizontally arranged. It is also possible to use, for example, a cylindrical micro fly's eye lens as the micro fly's eye lens 8. The configuration and action of the cylindrical micro fly's eye lens are disclosed, for example, in U.S. Pat. No. 6,913,373. The teachings of U.S. Pat. No. 6,913,373 are incorporated as reference herein.

The position of the predetermined plane 5 is arranged at or near the front focal point of the zoom lens 7 and an entrance surface of the micro fly's eye lens 8 is arranged at or near the rear focal point of the zoom lens 7. In other words, the zoom lens 7 arranges the predetermined plane 5 and the entrance surface of the micro fly's eye lens 8 substantially in a relation of Fourier transform and, in turn, arranges the pupil plane of the afocal lens 4 and the entrance surface of the micro fly's eye lens 8 so as to be substantially optically conjugate with each other.

Therefore, for example, an annular illumination field centered on the optical axis AX is formed on the entrance surface of the micro fly's eye lens 8 as on the pupil plane of the afocal lens 4. The overall shape of this annular illumination field similarly varies depending upon the focal length of the zoom lens 7. An entrance face of each micro lens (i.e., a unit wavefront division face) in the micro fly's eye lens 8 is, for example, a rectangular shape having the long sides along the Z-direction and the short sides along the X-direction and rectangular shape similar to a shape of an illumination region to be formed on the mask M (and, therefore, similar to a shape of an exposure region to be formed on the wafer W).

The beam incident to the micro fly's eye lens 8 is two-dimensionally divided to form a secondary light source with a light intensity distribution substantially identical to the illumination field formed on the entrance surface of the micro fly's eye lens 8, i.e., a secondary light source (pupil intensity distribution) consisting of a substantial surface illuminant of an annular shape centered on the optical axis AX, at the rear focal plane thereof or at a position near it (therefore, at the position of the illumination pupil). A second correction filter (transmission filter) 9 is arranged at or near the rear focal plane of the micro fly's eye lens 8. The configuration and action of the second correction filter 9 will be described later.

An illumination aperture stop (not shown) having an annular aperture region (light transmitting portion) corresponding to the annular secondary light source is arranged, when necessary, at or near the rear focal plane of the micro fly's eye lens 8. The illumination aperture stop is configured so as to be freely inserted into or retracted from the illumination optical path and so as to be switchable with a plurality of aperture stops with aperture regions of different sizes and shapes. A switching method of the aperture stops can be, for example, a well-known turret method, slide method, or the like. The illumination aperture stop is arranged at a position substantially optically conjugate with an entrance pupil plane of projection optical system PL described below, to define a range for the secondary light source to contribute to illumination.

The light having passed through the micro fly's eye lens 8 and the second correction filter 9 travels through a condenser optical system 10 to superposedly illuminate a mask blind 11. In this manner, a rectangular illumination field according to the shape and focal length of the micro lenses of the micro fly's eye lens 8 is formed on the mask blind 11 as an illumination field stop. The light having passed through a rectangular aperture region (light transmitting portion) of the mask blind 11 travels through an imaging optical system 12 consisting of a front lens unit 12a and a rear lens unit 12b, to superposedly illuminate the mask M on which a predetermined pattern is formed. Namely, the imaging optical system 12 forms an image of the rectangular aperture region of the mask blind 11 on the mask M.

The pattern to be transferred is formed on the mask M held on a mask stage MS and is illuminated in a pattern region of a rectangular shape (slit shape) having the long sides along the Y-direction and the short sides along the X-direction in the entire pattern region. Light transmitted by the pattern region of the mask M travels through the projection optical system PL to form an image of the mask pattern on the wafer (photosensitive substrate) W held on a wafer stage WS. Namely, the pattern image is also formed in a still exposure region (effective exposure region) of a rectangular shape having the long sides along the Y-direction and the short sides along the X-direction on the wafer W, so as to optically correspond to the rectangular illumination region on the mask M.

In this configuration, the mask stage MS and the wafer stage WS, therefore, the mask M and wafer W are synchronously moved (scanned) along the X-direction (scanning direction) in the plane (XY plane) perpendicular to the optical axis AX of the projection optical system PL in accordance with the so-called step-and-scan method, whereby scanning exposure of the mask pattern is effected in a shot area (exposure region) having a width equal to a Y-directional size of the still exposure region and a length according to a scan distance (movement distance) of the wafer W, on the wafer W.

In the present embodiment, as described above, the mask M arranged on the illumination target surface of the illumination optical system (2-12) is illuminated by Kohler illumination, using as a light source the secondary light source formed by the micro fly's eye lens 8. For this reason, the position where the secondary light source is formed is optically conjugate with a position of an aperture stop AS of the projection optical system PL and the forming position of the secondary light source can be called an illumination pupil plane of the illumination optical system (2-12). Typically, the illumination target surface (the surface where the mask M is arranged, or the surface where the wafer W is arranged in the case where the illumination optical system is considered to include the projection optical system PL) becomes an optical Fourier transform surface of the illumination pupil plane.

A pupil intensity distribution is a light intensity distribution (luminance distribution) on the illumination pupil plane of the illumination optical system (2-12) or on a plane optically conjugate with the illumination pupil plane. When the number of wavefront divisions by the micro fly's eye lens 8 is relatively large, there is a high correlation between a global light intensity distribution formed on the entrance surface of the micro fly's eye lens 8 and a global light intensity distribution (pupil intensity distribution) of the entire secondary light source. For this reason, light intensity distributions on the entrance surface of the micro fly's eye lens 8 and on a plane optically conjugate with the entrance surface can also be called pupil intensity distributions. In the configuration of FIG. 1, the diffractive optical element 3, afocal lens 4, zoom lens 7, and micro fly's eye lens 8 constitute a distribution forming optical system to form the pupil intensity distribution on the illumination pupil located behind the micro fly's eye lens 8.

The diffractive optical element 3 for annular illumination may be replaced with another diffractive optical element (not shown) for multi-polar illumination (dipolar illumination, quadrupolar illumination, octupolar illumination, or the like) set in the illumination optical path, so as to implement the multi-polar illumination. The diffractive optical element for multi-polar illumination has such a function that when a parallel beam with a rectangular cross section is incident thereto, it forms a light intensity distribution of a multi-polar shape (dipolar shape, quadrupolar shape, octupolar shape, or the like) in its far field. Therefore, the beam having passed through the diffractive optical element for multi-polar illumination forms, for example, an illumination field of a multi-polar shape consisting of a plurality of illumination areas of a predetermined shape (arcuate shape, circular shape, or the like) centered on the optical axis AX, on the entrance surface of the micro fly's eye lens 8. As a consequence, a secondary light source of a multi-polar shape identical to the illumination field formed on the entrance surface is also formed on or near the rear focal plane of the micro fly's eye lens 8.

When a diffractive optical element for circular illumination (not shown) is set, instead of the diffractive optical element 3 for annular illumination, in the illumination optical path, ordinary circular illumination can be implemented. The diffractive optical element for circular illumination has such a function that when a parallel beam with a rectangular cross section is incident thereto, it forms a light intensity distribution of a circular shape in its far field. Therefore, a beam having passed through the diffractive optical element for circular illumination forms, for example, an illumination field of a circular shape centered on the optical axis AX, on the entrance surface of the micro fly's eye lens 8. As a consequence, a secondary light source of a circular shape identical to the illumination field formed on the entrance surface is also formed on or near the rear focal plane of the micro fly's eye lens 8. Furthermore, modified illuminations of various forms can also be implemented by setting a diffractive optical element with an appropriate property (not shown) in the illumination optical path, instead of the diffractive optical element 3 for annular illumination. A switching method of diffractive optical element 3 can be, for example, a well-known turret method, slide method, or the like.

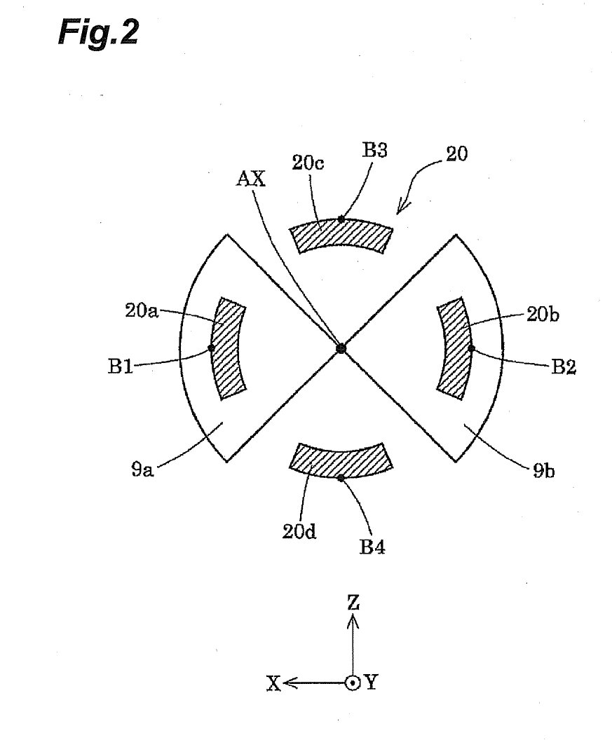

It is assumed in the description hereinafter, for easier understanding of the action and effect of the present embodiment, that a pupil intensity distribution (secondary light source) 20 of a quadrupolar shape as shown in FIG. 2 is formed on the rear focal plane of the micro fly's eye lens 8 or on the illumination pupil near it. It is also assumed that the second correction filter 9 is arranged behind (or on the mask side of) the plane where the pupil intensity distribution 20 of the quadrupolar shape is formed. When the “illumination pupil” is simply used in the description hereinafter, it means the rear focal plane of the micro fly's eye lens 8 or the illumination pupil near it.

With reference to FIG. 2, the pupil intensity distribution 20 of the quadrupolar shape formed on the illumination pupil has a pair of substantial surface illuminants of an arcuate shape (which will be referred to simply as “surface illuminants”) 20a, 20b spaced in the X-direction on both sides of the optical axis AX, and a pair of substantial surface illuminants 20c, 20d of an arcuate shape spaced in the Z-direction on both sides of the optical axis AX. The X-direction on the illumination pupil is the short-side direction of the rectangular micro lenses of the micro fly's eye lens 8 and corresponds to the scanning direction of the wafer W. The Z-direction on the illumination pupil is the long-side direction of the rectangular micro lenses of the micro fly's eye lens 8 and corresponds to an orthogonal-to-scan direction (the Y-direction on the wafer W) perpendicular to the scanning direction of the wafer W.

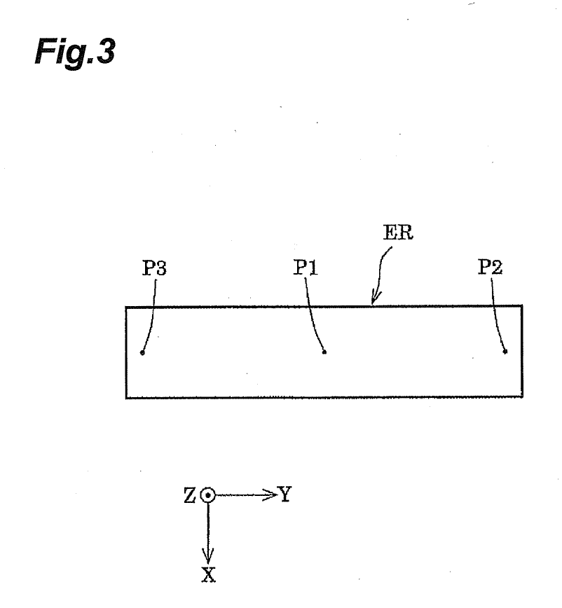

As shown in FIG. 3, a still exposure region ER of a rectangular shape having the long sides along the Y-direction and the short sides along the X-direction is formed on the wafer W and a rectangular illumination region (not shown) is formed on the mask M so as to correspond to this still exposure region ER. It is noted herein that the quadrupolar pupil intensity distribution formed on the illumination pupil by light incident to a point in the still exposure region ER has much the same shape, independent of positions of incident points. However, light intensities of respective surface illuminants forming the quadrupolar pupil intensity distribution tend to differ depending upon positions of incident points.

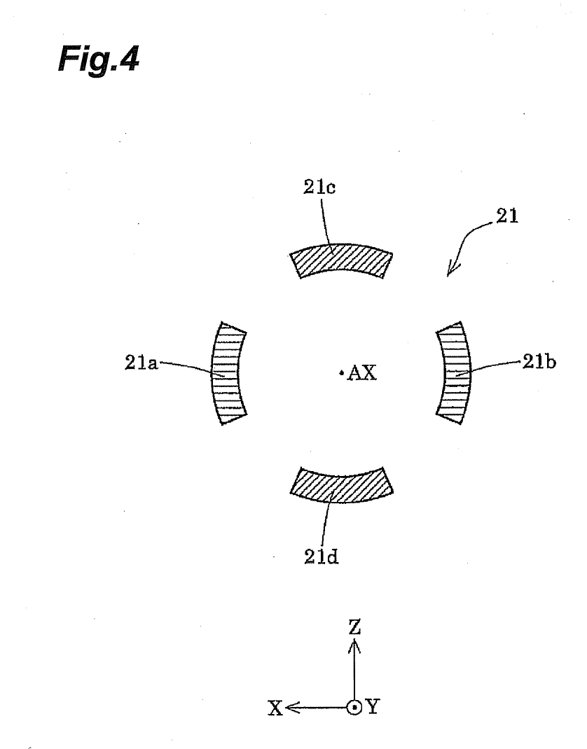

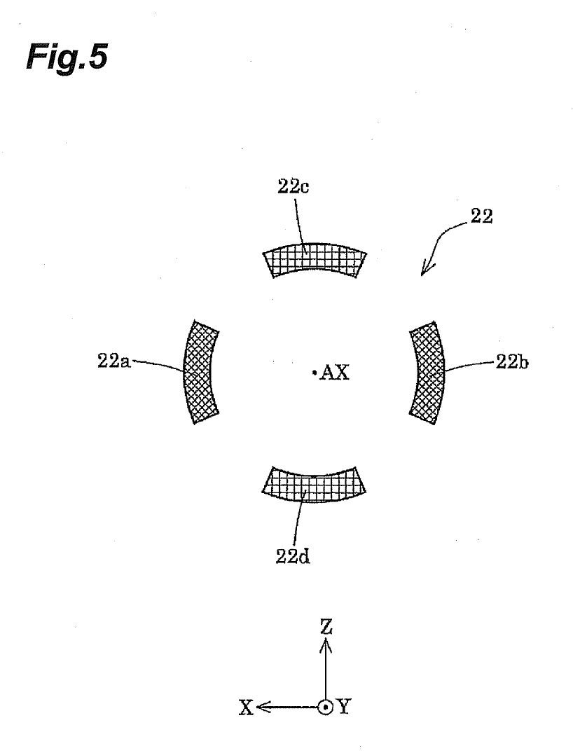

Specifically, in the case of a quadrupolar pupil intensity distribution 21 formed by light incident to a center point P1 in the still exposure region ER, as shown in FIG. 4, the light intensity of the surface illuminants 21c and 21d spaced in the Z-direction tends to become larger than the light intensity of the surface illuminants 21a and 21b spaced in the X-direction. On the other hand, in the case of a quadrupolar pupil intensity distribution 22 formed by light incident to peripheral points P2, P3 spaced in the Y-direction apart from the center point P1 in the still exposure region ER, as shown in FIG. 5, the light intensity of the surface illuminants 22c and 22d spaced in the Z-direction tends to become smaller than the light intensity of the surface illuminants 22a and 22b spaced in the X-direction.

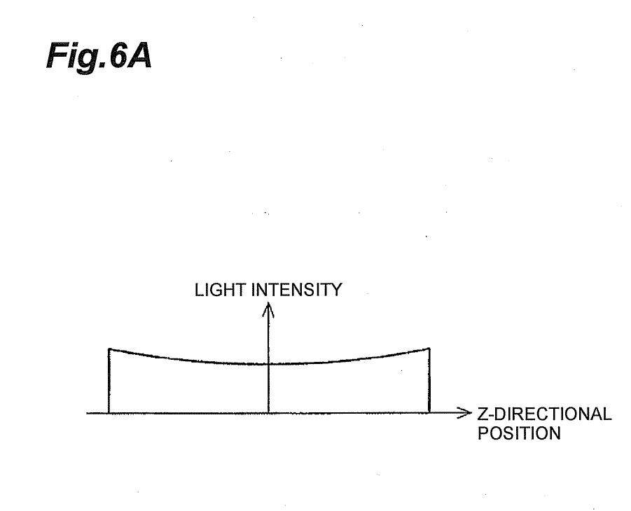

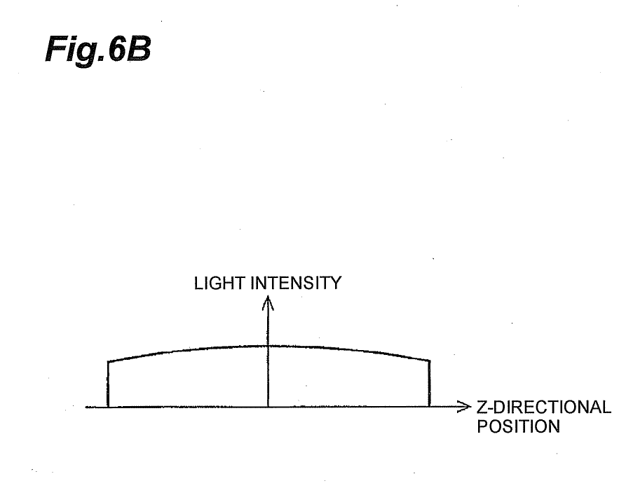

In general, regardless of the contour of the pupil intensity distribution formed on the illumination pupil, a light intensity profile along the Z-direction of the pupil intensity distribution related to the center point P1 in the still exposure region ER on the wafer W (the pupil intensity distribution formed on the illumination pupil by the light incident to the center point P1) has a profile of a concave curve shape in which the intensity is minimum in the center and increases toward the periphery, as shown in FIG. 6A. On the other hand, a light intensity profile along the Z-direction of the pupil intensity distribution related to the peripheral points P2, P3 in the still exposure region ER on the wafer W has a profile of a convex curve shape in which the intensity is maximum in the center and decreases toward the periphery, as shown in FIG. 6B.

The light intensity profile along the Z-direction of the pupil intensity distribution is not very dependent on positions of incident points along the X-direction (scanning direction) in the still exposure region ER, but tends to vary depending upon positions of incident points along the Y-direction (orthogonal-to-scan direction) in the still exposure region ER. When each of the pupil intensity distributions related to respective points in the still exposure region ER on the wafer W (pupil intensity distributions formed on the illumination pupil by light incident to respective points) is not substantially uniform as in this case, the line width of the pattern varies depending upon positions on the wafer W, so as to fail in faithfully transferring the microscopic pattern of the mask M in a desired line width across the entire exposure region on the wafer W.

In the present embodiment, as described above, the first correction filter 6 with the transmittance distribution of different transmittances depending upon positions of incidence of light is arranged at or near the pupil position of the afocal lens 4. The pupil position of the afocal lens 4 is optically conjugate with the entrance surface of the micro fly's eye lens 8 by virtue of the rear lens unit 4b of the afocal lens 4 and the zoom lens 7. Therefore, the light intensity distribution formed on the entrance surface of the micro fly's eye lens 8 is adjusted (or corrected) by the action of the first correction filter 6 and, in turn, the pupil intensity distribution formed on the rear focal plane of the micro fly's eye lens 8 or on the illumination pupil near it is also adjusted.

However, the first correction filter 6 equally adjusts the pupil intensity distributions related to respective points in the still exposure region ER on the wafer W, independent on positions of the respective points. As a consequence, it is possible, for example, to substantially uniformly adjust the quadrupolar pupil intensity distribution 21 related to the center point P1 and, in turn, to make the light intensities of the respective surface illuminants 21a-21d approximately equal to each other by the action of the first correction filter 6, but in that case, the difference becomes larger on the contrary between the light intensities of the surface illuminants 22a, 22b and the surface illuminants 22c, 22d of the quadrupolar pupil intensity distribution 22 related to the peripheral points P2, P3.

Namely, in order to substantially uniformly adjust each of the pupil intensity distributions related to the respective points in the still exposure region ER on the wafer W by the action of the first correction filter 6, the pupil intensity distributions related to the respective points can be adjusted to distributions of mutually identical properties by another means different from the first correction filter 6. Specifically, for example, in the pupil intensity distribution 21 related to the center point P1 and the pupil intensity distribution 22 related to the peripheral points P2, P3, it can make the magnitude relation of light intensities between the surface illuminants 21a, 21b and the surface illuminants 21c, 21d and the magnitude relation of light intensities between the surface illuminants 22a, 22b and the surface illuminants 22c, 22d coincident at a nearly equal ratio.

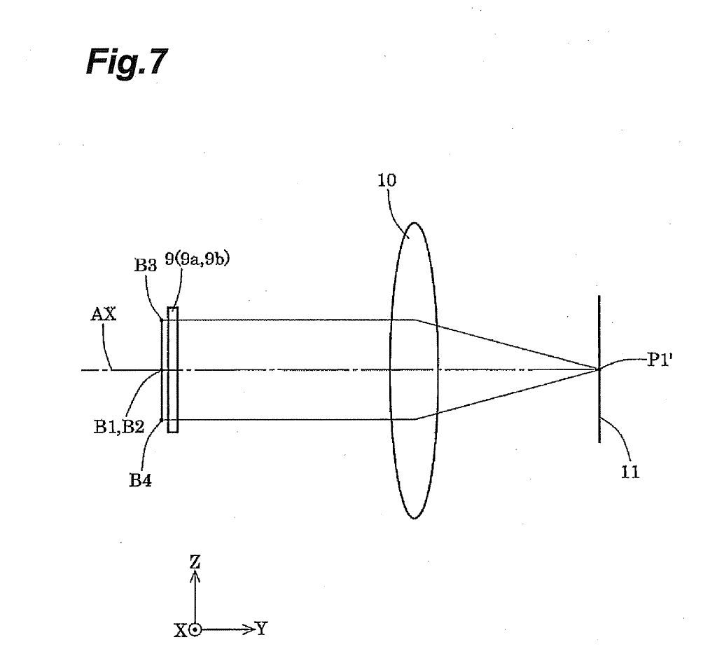

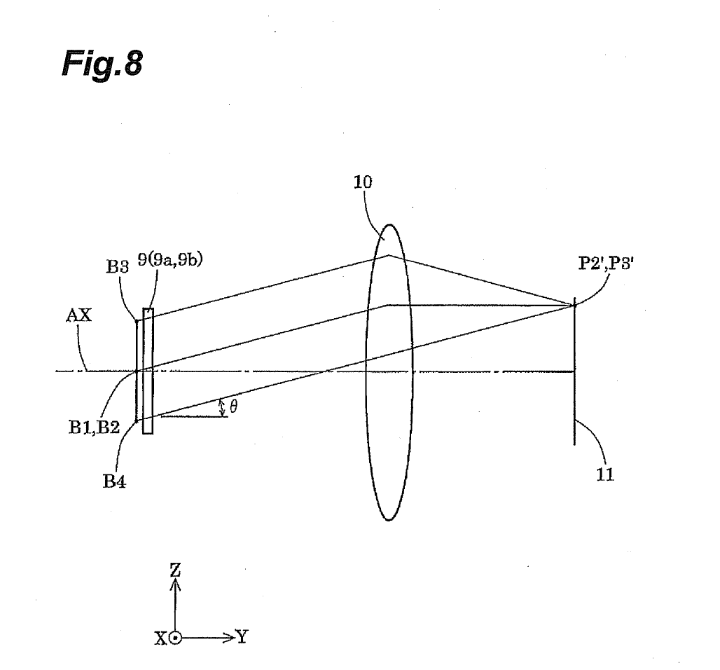

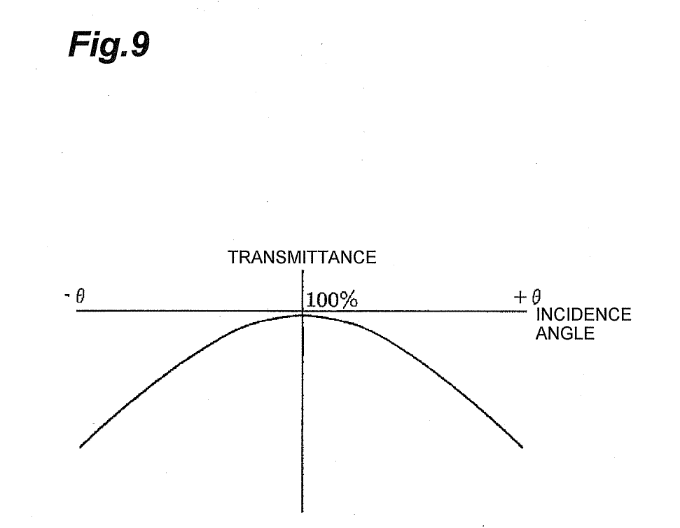

In the present embodiment, in order to make the property of the pupil intensity distribution related to the center point P1 approximately coincident with the property of the pupil intensity distribution related to the peripheral points P2, P3, the second correction filter 9 is provided as a transmission filter for realizing such adjustment that the light intensity of the surface illuminants 22a, 22b becomes smaller than the light intensity of the surface illuminants 22c, 22d in the pupil intensity distribution 22 related to the peripheral points P2, P3. FIGS. 7 and 8 are drawings to illustrate the action of the second correction filter 9 in the present embodiment. FIG. 9 is a drawing showing the transmittance characteristic of the second correction filter 9 in the present embodiment.

The second correction filter 9, as shown in FIG. 2, has a pair of transmission filter regions 9a and 9b arranged corresponding to the pair of surface illuminants 20a, 20b spaced in the X-direction on both sides of the optical axis AX. As a result, light from the surface illuminant 20a in the quadrupolar pupil intensity distribution 20 passes through the transmission filter region 9a and light from the surface illuminant 20b in the quadrupolar pupil intensity distribution 20 passes through the transmission filter region 9b, but light from the surface illuminants 20c, 20d is not subjected to the action of the second correction filter 9. The second correction filter 9, as shown in FIG. 9, has the transmittance characteristic varying depending upon the angle of incidence of light, specifically, the transmittance characteristic of decreasing the transmittance with increase in the angle of incidence of light.

In this case, as shown in FIG. 7, the light arriving at the center point P1 in the still exposure region ER on the wafer W, i.e., the light arriving at a center point P1′ of the aperture region of the mask blind 11 is incident at the incidence angle of 0 to the second correction filter 9. In other words, the light from the surface illuminants 21a and 21b of the pupil intensity distribution 21 related to the center point P1 is incident at the incidence angle of 0 to the pair of transmission filter regions 9a and 9b. On the other hand, as shown in FIG. 8, the light arriving at the peripheral points P2, P3 in the still exposure region ER on the wafer W, i.e., the light arriving at peripheral points P2′, P3′ of the aperture region of the mask blind 11 is incident at incidence angles ±θ to the second correction filter 9. In other words, the light from the surface illuminants 22a and 22b of the pupil intensity distribution 22 related to the peripheral points P2, P3 is incident at the incidence angles ±θ to each of the pair of transmission filter regions 9a and 9b.

In FIGS. 7 and 8, reference symbol B1 denotes an outermost edge point along the X-direction of the surface illuminant 20a (21a, 22a) (cf. FIG. 2) and reference symbol B2 an outermost edge point along the X-direction of the surface illuminant 20b (21b, 22b) (cf. FIG. 2). Furthermore, for easier understanding of the description associated with FIGS. 7 and 8, an outermost edge point along the Z-direction of the surface illuminant 20c (21c, 22c) is denoted by reference symbol B3 and an outermost edge point along the Z-direction of the surface illuminant 20d (21d, 22d) by reference symbol B4. However, as described above, the light from the surface illuminant 20c (21c, 22c) and the surface illuminant 20d (21d, 22d) is not subjected to the action of the second correction filter 9.

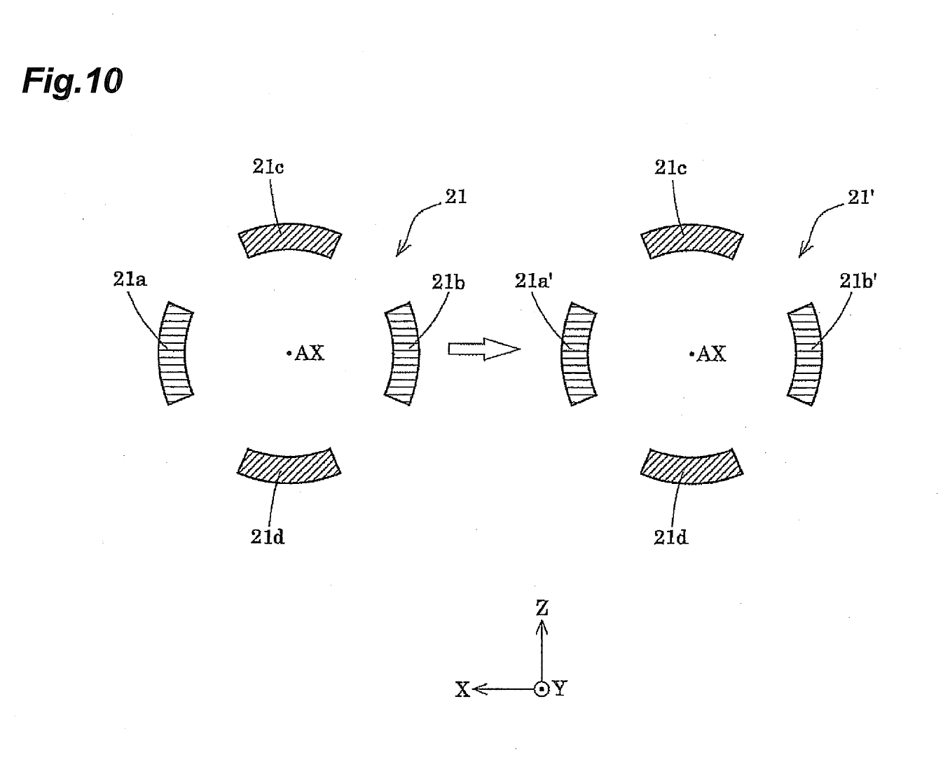

In this manner, the light from the surface illuminants 21a and 21b in the pupil intensity distribution 21 related to the center point P1 is subjected to the action of the transmission filter regions 9a and 9b of the second correction filter 9, but shows little change in the light intensity thereof. The light from the surface illuminants 21c and 21d is not subjected to the action of the second correction filter 9 and thus shows no change in its light intensity. As a result, even when the pupil intensity distribution 21 related to the center point P1 is subjected to the action of the second correction filter 9, as shown in FIG. 10, it is only slightly adjusted to a pupil intensity distribution 21′ of a property nearly equal to that of the original distribution 21. Namely, the pupil intensity distribution 21′ adjusted by the second correction filter 9 maintains the property that the light intensity of the surface illuminants 21c, 21d spaced in the Z-direction is larger than the light intensity of surface illuminants 21a′, 21b′ spaced in the X-direction.

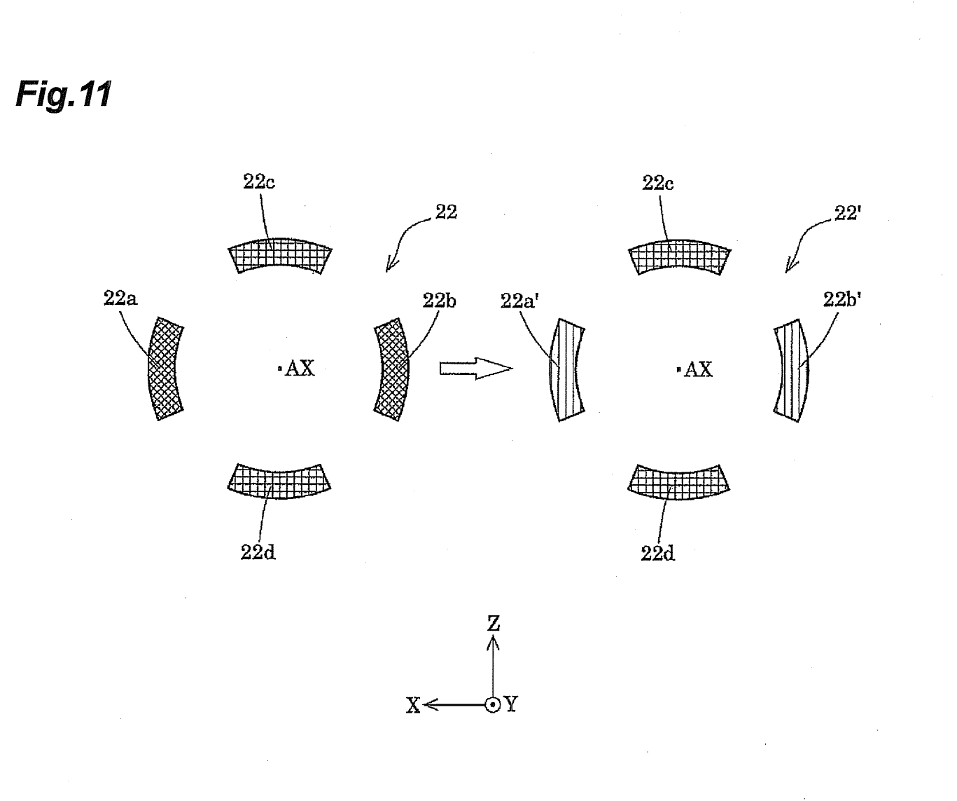

On the other hand, the light from the surface illuminants 22a and 22b in the pupil intensity distribution 22 related to the peripheral points P2, P3 is subjected to the action of the transmission filter regions 9a and 9b of the second correction filter 9 to decrease the light intensity thereof. Since the light from the surface illuminants 22c and 22d is not subjected to the action of the second correction filter 9, there is no change in the light intensity thereof. As a result, the pupil intensity distribution 22 related to the peripheral points P2, P3 is adjusted to a pupil intensity distribution 22′ of a property different from that of the original distribution 22, as shown in FIG. 11, by the action of the second correction filter 9. Namely, the pupil intensity distribution 22′ adjusted by the second correction filter 9 comes to have the property that the light intensity of the surface illuminants 22c, 22d spaced in the Z-direction is larger than the light intensity of surface illuminants 22a′, 22b′ spaced in the X-direction.

In this manner, the pupil intensity distribution 22 related to the peripheral points P2, P3 is adjusted to the distribution 22′ of the property substantially equal to that of the pupil intensity distribution 21′ related to the center point P1 by the action of the second correction filter 9. Similarly, the pupil intensity distributions related to respective points arranged along the Y-direction between the center point P1 and the peripheral points P2, P3, therefore, the pupil intensity distributions related to respective points in the still exposure region ER on the wafer W are also adjusted to distributions of nearly identical properties to that of the pupil intensity distribution 21′ related to the center point P1. In other words, the pupil intensity distributions related to the respective points in the still exposure region ER on the wafer W are adjusted to distributions of substantially mutually identical properties by the action of the second correction filter 9. In still another expression, the second correction filter 9 has the required transmittance characteristic varying depending upon the angle of incidence of light, in order to adjust the pupil intensity distributions related to the respective points, to distributions of substantially mutually identical properties.

In the illumination optical system of the present embodiment, as described above, the pupil intensity distributions related to the respective points each are substantially uniformly adjusted through collaboration between the second correction filter 9 with the required transmittance characteristic varying depending upon the angle of incidence of light, to independently adjust each of the pupil intensity distributions related to the respective points in the still exposure region ER on the wafer W, and the first correction filter 6 with the required transmittance characteristic varying depending upon the position of incidence of light, to equally adjust the pupil intensity distributions related to the respective points. Therefore, the exposure apparatus (2-WS) of the present embodiment is able to perform excellent exposure under an appropriate illumination condition according to the microscopic pattern of the mask M, using the illumination optical system (2-12) to substantially uniformly adjust each of the pupil intensity distributions for the respective points in the still exposure region ER on the wafer W, and therefore to faithfully transfer the microscopic pattern of the mask M in a desired line width across the entire exposure region on the wafer W.

Namely, for faithfully transferring the microscopic pattern of the mask onto the wafer, it can be not only to adjust the pupil intensity distribution to a desired shape but also to adjust each of pupil intensity distributions related to respective points on the wafer as a final illumination target surface to desired distributions. When there is variation in uniformity of the pupil intensity distributions for the respective points on the wafer, the line width of the pattern will vary depending upon positions on the wafer, so as to result in failure in faithfully transferring the microscopic pattern of the mask in a desired line width across the entire exposure region on the wafer.

Whereas, in the illumination optical system according to the embodiment of the present invention, the second correction filter 9 which is a transmission filter with the transmittance characteristic varying depending upon the angle of incidence of light is arranged at or near the position of the illumination pupil located behind the micro fly's eye lens 8 which is an optical integrator. Therefore, when each of pupil intensity distributions related to respective points on the illumination target surface is independently adjusted by action of this transmission filter, the pupil intensity distributions related to the respective points can be adjusted to distributions with mutually nearly identical properties.

As a consequence, the illumination optical system according to the embodiment of the present invention is able to substantially uniformly adjust each of the pupil intensity distributions for respective points on the illumination target surface, for example, through collaboration between the transmission filter (the second correction filter 9) to independently adjust each of the pupil intensity distributions related to the respective points and another correction filter (the first correction filter 6) to equally adjust the pupil intensity distributions for respective points on the illumination target surface. In this manner, the exposure apparatus according to the embodiment of the present invention is able to perform excellent exposure under an appropriate illumination condition, using the illumination optical system to substantially uniformly adjust each of the pupil intensity distributions for respective points on the illumination target surface, and therefore to manufacture excellent devices.

It is considered in the present embodiment that the light quantity distribution on the wafer (illumination target surface) W is affected, for example, by the adjusting action of the second correction filter 9. In this case, the illuminance distribution in the still exposure region ER or the shape of the still exposure region (illumination region) ER can be modified by action of a light quantity distribution adjuster having a known configuration when necessary. Specifically, the light quantity distribution adjuster to modify the illuminance distribution can be one using the configuration and technique described in Japanese Patent Applications Laid-open No. 2001-313250 and Laid-open No. 2002-100561 (and U.S. Pat. No. 6,771,350 and No. 6,927,836 corresponding thereto). The light quantity distribution adjuster to modify the shape of the illumination region can be one using the configuration and technique described in International Publication WO2005/048326 (and U.S. Pat. Published Application No. 2007/0014112 corresponding thereto). Teachings of U.S. Pat. Nos. 6,771,350 and 6,927,836, and U.S. Pat. Published Application No. 2007/0014112 are incorporated herein by reference.

In the above description, the action and effect of the embodiment of the present invention were described using the example of the modified illumination to form the quadrupolar pupil intensity distribution on the illumination pupil, i.e., the quadrupolar illumination. However, it is obvious that, without having to be limited to the quadrupolar illumination, the embodiment of the present invention is also similarly applicable with the same action and effect, for example, to the annular illumination to form the pupil intensity distribution of the annular shape and to multi-polar illumination to form the pupil intensity distribution of a multi-polar shape other than the quadrupolar shape.

In the above description, the second correction filter 9 as the transmission filter with the transmittance characteristic varying depending upon the angle of incidence of light is arranged behind (or on the mask side of) the forming surface of the pupil intensity distribution 20 formed on the rear focal plane of the micro fly's eye lens 8 or on the illumination pupil near it. However, without having to be limited to this, the second correction filter 9 may also be arranged at the position of the forming surface of the pupil intensity distribution 20, or in front of it (or on the light source side). Furthermore, the second correction filter 9 can also be arranged at or near a position of another illumination pupil behind the micro fly's eye lens 8, e.g., at or near the position of the illumination pupil between the front lens unit 12a and the rear lens unit 12b of the imaging optical system 12.

In general, a transmission filter with a transmittance characteristic varying depending upon an angle of incidence of light can be arranged at a position of incidence of light to pass through only a partial region of the illumination pupil or light having passed through only a partial region of the illumination pupil, in an illumination pupil space between an optical element with a power adjacent in front of the illumination pupil located behind the optical integrator and an optical element with a power adjacent behind the illumination pupil. Namely, a plane-parallel plate or a planar mirror without power may exist in this “illumination pupil space.”

In the above embodiment, the second correction filter 9 as the transmission filter with the transmittance characteristic varying depending upon the angle of incidence of light may be configured to be rotatable around the optical axis AX of the illumination optical system or around an axis parallel to the optical axis AX. The second correction filter 9 may also be configured to be tiltable about an axis perpendicular to the optical axis AX of the illumination optical system. The second correction filter 9 may also be configured to be movable along a direction crossing the optical axis AX of the illumination optical system (typically, the direction perpendicular to the optical axis AX).

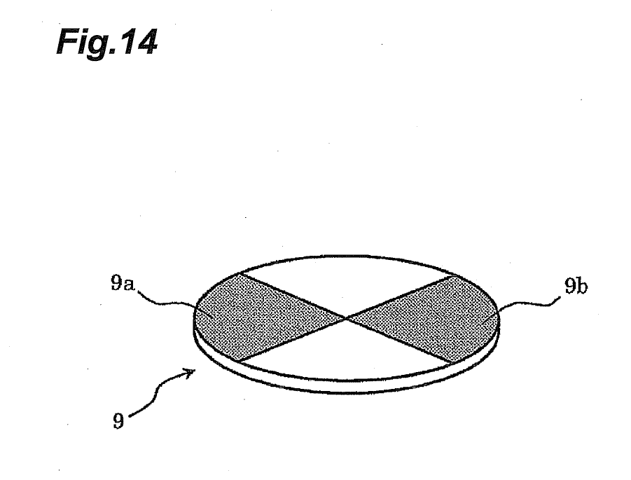

In the above embodiment, the second correction filter 9 may be one provided with partial transmission filter regions 9a, 9b on a single optically transparent substrate (plane-parallel plate), as shown in FIG. 14.

In the above embodiment, the second correction filter 9 may be provided so as to be replaceable with another second correction filter with a different characteristic (both or either of a configuration having a different transmittance characteristic and a configuration in which the transmission filter regions are provided at different positions).

In the above embodiment, the first correction filter 6 with the transmittance distribution of different transmittances depending upon positions of incidence of light may be configured so as to be rotatable around the optical axis AX of the illumination optical system or around an axis parallel to the optical axis AX, tiltable about the axis perpendicular to the optical axis AX of the illumination optical system, or movable along a direction crossing the optical axis AX of the illumination optical system (typically, the direction perpendicular to the optical axis AX).

The exposure apparatus of the foregoing embodiment is manufactured by assembling various sub-systems containing their respective components as set forth in the scope of claims in the present application, so as to maintain predetermined mechanical accuracy, electrical accuracy, and optical accuracy. For ensuring these various accuracies, the following adjustments are carried out before and after the assembling: adjustment for achieving the optical accuracy for various optical systems; adjustment for achieving the mechanical accuracy for various mechanical systems; adjustment for achieving the electrical accuracy for various electrical systems. The assembling blocks from the various sub-systems into the exposure apparatus include mechanical connections, wire connections of electric circuits, pipe connections of pneumatic circuits, etc. between the various sub-systems. It is needless to mention that there are assembling blocks of the individual sub-systems, before the assembling blocks from the various sub-systems into the exposure apparatus. After completion of the assembling blocks from the various sub-systems into the exposure apparatus, overall adjustment is carried out to ensure various accuracies as the entire exposure apparatus. The manufacture of exposure apparatus may be performed in a clean room in which the temperature, cleanliness, etc. are controlled.

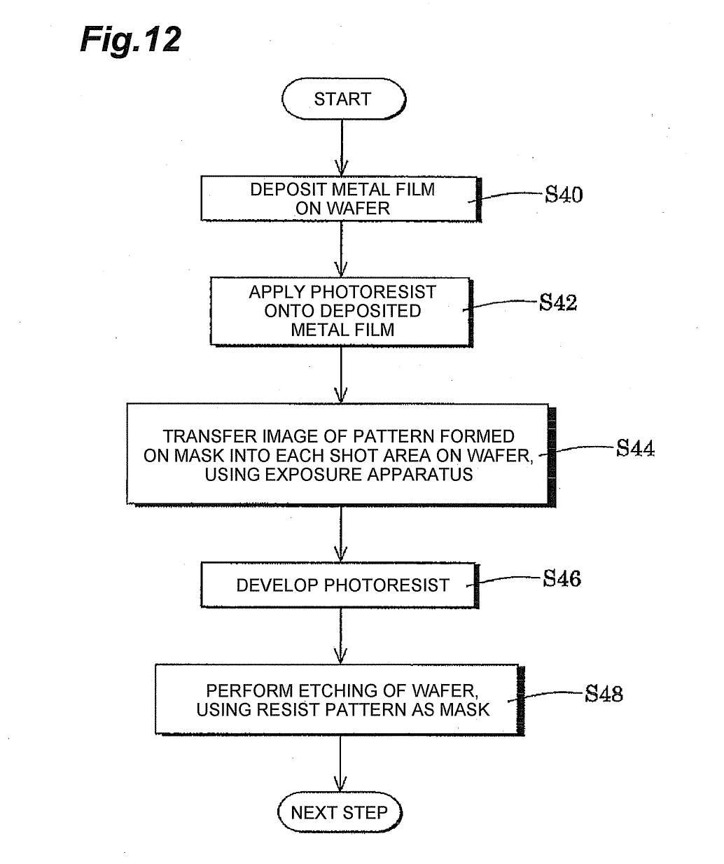

The following will describe a device manufacturing method using the exposure apparatus according to the above-described embodiment. FIG. 12 is a flowchart showing manufacturing blocks of semiconductor devices. As shown in FIG. 12, the manufacturing blocks of semiconductor devices include depositing a metal film on a wafer W to become a substrate of semiconductor devices (block S40) and applying a photoresist as a photosensitive material onto the deposited metal film (block S42). The subsequent blocks include transferring a pattern formed on a mask (reticle) M, into each shot area on the wafer W, using the exposure apparatus of the aforementioned embodiment (block S44: exposure block), and developing the wafer W after completion of the transfer, i.e., developing the photoresist on which the pattern has been transferred (block S46: development block). Thereafter, using as a mask the resist pattern made on the surface of the wafer W in block S46, processing such as etching is carried out on the surface of the wafer W (block S48: processing block).

The resist pattern herein is a photoresist layer in which depressions and projections are formed in a shape corresponding to the pattern transferred by the exposure apparatus of the embodiment and which the depressions penetrate throughout. Block S48 is to process the surface of the wafer W through this resist pattern. The processing carried out in block S48 includes, for example, at least either etching of the surface of the wafer W or deposition of a metal film or the like. In block S44, the exposure apparatus of the embodiment performs the transfer of the pattern onto the wafer W coated with the photoresist, as a photosensitive substrate or plate P.

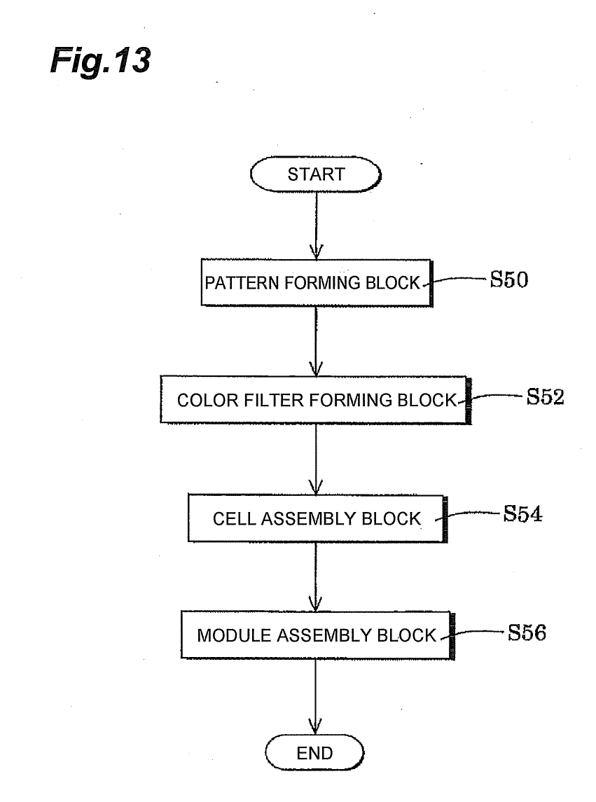

FIG. 13 is a flowchart showing manufacturing blocks of a liquid crystal device such as a liquid crystal display device. As shown in FIG. 13, the manufacturing blocks of the liquid crystal device include sequentially performing a pattern forming block (block S50), a color filter forming block (block S52), a cell assembly block (block S54), and a module assembly block (block S56).

The pattern forming block of block S50 is to form predetermined patterns such as a circuit pattern and an electrode pattern on a glass substrate coated with a photoresist, as a plate P, using the exposure apparatus of the embodiment. This pattern forming block includes an exposure block of transferring a pattern to a photoresist layer, using the exposure apparatus of the embodiment, a development block of performing development of the plate P on which the pattern has been transferred, i.e., development of the photoresist layer on the glass substrate, to make the photoresist layer in the shape corresponding to the pattern, and a processing block of processing the surface of the glass substrate through the developed photoresist layer.

The color filter forming block of block S52 is to form a color filter in which a large number of sets of three dots corresponding to R (Red), G (Green), and B (Blue) are arrayed in a matrix pattern, or in which a plurality of filter sets of three stripes of R, Q and B are arrayed in a horizontal scan direction.

The cell assembly block of block S54 is to assemble a liquid crystal panel (liquid crystal cell), using the glass substrate on which the predetermined pattern has been formed in block S50, and the color filter formed in block S52. Specifically, for example, a liquid crystal is poured into between the glass substrate and the color filter to form the liquid crystal panel. The module assembly block of block S56 is to attach various components such as electric circuits and backlights for display operation of this liquid crystal panel, to the liquid crystal panel assembled in block S54.

The embodiment of the present invention relates to an illumination optical system suitably applicable to exposure apparatus, for example, for manufacturing devices such as semiconductor devices, imaging devices, liquid crystal display devices, and thin film magnetic heads by lithography.

The embodiment of the present invention is not limited just to the application to the exposure apparatus for manufacture of semiconductor devices, but can also be widely applied, for example, to the exposure apparatus for the liquid-crystal display devices formed with rectangular glass plates, or for display devices such as plasma displays, and the exposure apparatus for manufacture of various devices such as imaging devices (CCDs and others), micro machines, thin film magnetic heads, and DNA chips. Furthermore, the embodiment of the present invention is also applicable to the exposure block (exposure apparatus) for manufacturing masks (photomasks, reticles, etc.) on which mask patterns of various devices are formed, by the photolithography process.

The above-described embodiment used the ArF excimer laser light (wavelength: 193 nm) or the KrF excimer laser light (wavelength: 248 nm) as the exposure light, but, without having to be limited to this, the embodiment of the present invention can also be applied to any other appropriate laser light source, e.g., an F₂ laser light source which supplies laser light at the wavelength of 157 nm.

The aforementioned embodiment was the application of the embodiment of the present invention to the exposure apparatus of the step-and-scan method to perform scanning exposure of the pattern on the mask M into the shot area on the wafer W. However, without having to be limited to this, the embodiment of the present invention can also be applied to the exposure apparatus of the step-and-repeat method to repeat an operation of performing one-shot exposure of the pattern on the mask M into each exposure region on the wafer W.

The aforementioned embodiment was the application of the present invention to the illumination optical system to illuminate the mask or the wafer in the exposure apparatus, but, without having to be limited to this, the present invention can also be applied to a generally-used illumination optical system which illuminates an illumination target surface except for the mask or the wafer.

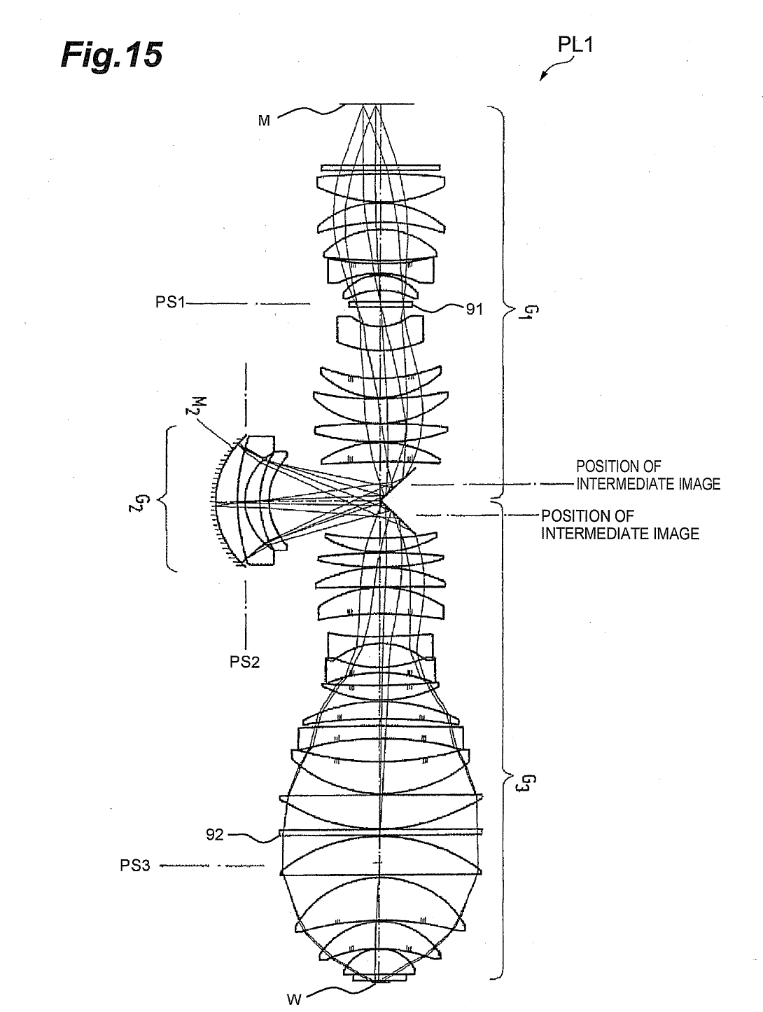

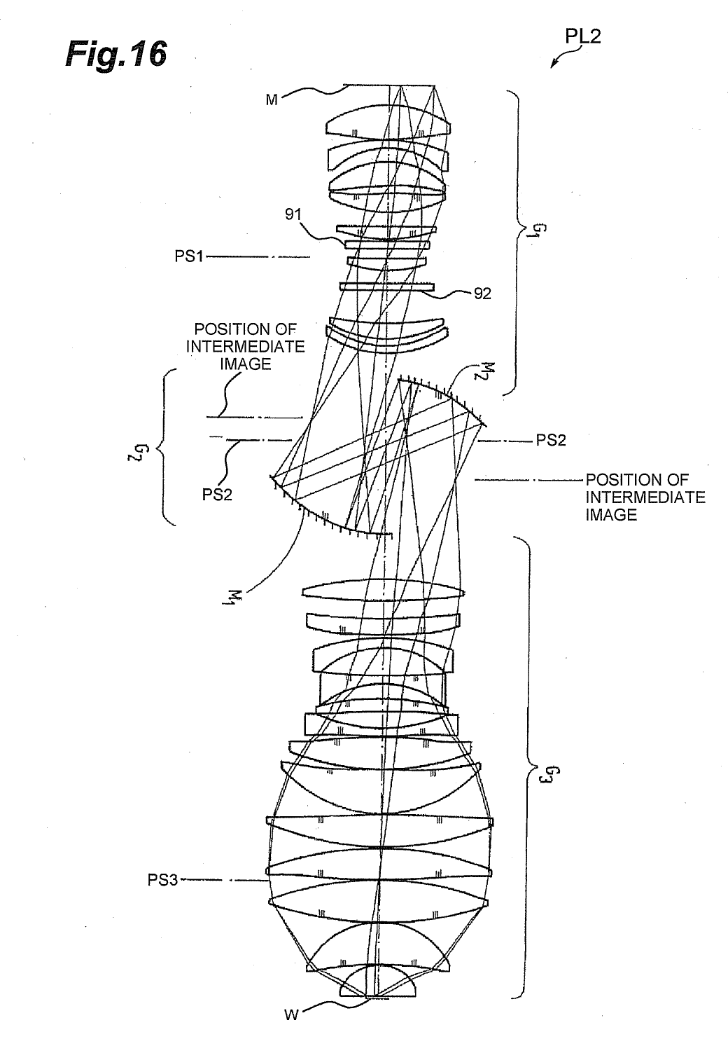

The second correction filter 9 as the transmission filter does not always have to be arranged in the illumination pupil space inside the illumination optical system, but may be arranged at a position in the projection optical system conjugate with the illumination pupil space. Namely, the second correction filter 9 may be arranged not only in the illumination optical system, but also in the projection optical system being an exposure optical system. FIGS. 15 and 16 show examples of projection optical systems in which the second correction filter 9 is arranged.

The projection optical system PL1 shown in FIG. 15 is constructed with a dioptric imaging system G1 to form an intermediate image of an object, a catadioptric imaging system G2 to form an image of the intermediate image, and a dioptric imaging system G3 to form an image of the intermediate image formed by the catadioptric imaging system G2, as a final image on a wafer surface. This projection optical system PL1 has a plane where an aperture stop is arranged, and pupil planes PS1-PS3 being planes conjugate therewith. Plane-parallel plates 91, 92 are arranged near the pupil plane PS1 and near the pupil plane PS3 and at least one of these plane-parallel plates 91, 92 can be the second correction filter 9.

The projection optical system PL2 shown in FIG. 16 is constructed with a dioptric imaging system G1 to form an intermediate image of an object, a catoptric imaging system G2 to form an image of the intermediate image, and a dioptric imaging system G3 to form an image of the intermediate image formed by the catoptric imaging system G2, as a final image on a wafer surface. This projection optical system PL2 has a plane where an aperture stop is arranged, and pupil planes PS1-PS3 being planes conjugate therewith. Plane-parallel plates 91, 92 are arranged near the pupil plane PS1 and the plane-parallel plate 91 can be the second correction filter 9. The plane-parallel plate may be set as the second correction filter.

Although the wavefront division type micro fly's eye lens (fly's eye lens) with a plurarity of micro lenses is used as an optical integrator in the foregoing embodiment, instead, an optical integrator of the inner-surface reflection type, which is typically a rod type integrator, may be used instead. In this case, the condenser lens is arranged behind the zoom lens 7 so that the front focus position of the condenser lens agrees with the rear focus position of the zoom lens 7 and the rod type integrator is arranged so that the entrance end of the rod type integrator is set at or around the rear focus position of the condenser lens. In this case, the exit end of the rod type integrator set the position of the mask blind 11. When the rod type integrator is used, the position which is optically conjugate with the position of the aperture stop AS of the projection optical system PL in the imaging optical system 12 down the rod type integrator can be described as an illumination pupil plane. Since virtual images of the secondary optical sources of the illumination pupil plane is formed at the position of the entrance surface of the rod type integrator, the position of the entrance surface of the rod type integrator and a position which is optically conjugate with the position can be described as an illumination pupil plane. The second correction filter 9 in the foregoing embodiment can be arranged at or around a position which is optically conjugate with the aperture stop AS of the projection optical system PL in the imaging optical system 12 down the rod type integrator.

In the foregoing embodiment, it is also possible to apply the so-called liquid immersion method, which is a technique of filling a medium (typically, a liquid) with a refractive index larger than 1.1 in the optical path between the projection optical system and the photosensitive substrate. In this case, the technique of filling the liquid in the optical path between the projection optical system and the photosensitive substrate can be selected from the technique of locally filling the liquid as disclosed in PCT International Publication No. WO99/49504, the technique of moving a stage holding a substrate as an exposure target in a liquid bath as disclosed in Japanese Patent Application Laid-Open No. 6-124873, the technique of forming a liquid bath in a predetermined depth on a stage and holding the substrate therein as disclosed in Japanese Patent Application Laid-Open No. 10-303114, and so on. In the foregoing embodiment, it is also possible to apply the so-called polarized illumination method disclosed in U.S Pat. Published Application Nos. 2006/0203214, 2006/0170901, and 2007/0146676. Teachings of the U.S Pat. Published Application Nos. 2006/0203214, 2006/0170901, and 2007/0146676 are incorporated herein by reference.

The invention is not limited to the fore going embodiments but various changes and modifications of its components may be made without departing from the scope of the present invention. Also, the components disclosed in the embodiments may be assembled in any combination for embodying the present invention. For example, some of the components may be omitted from all components disclosed in the embodiments. Further, components in different embodiments may be appropriately combined.

What is claimed is:

1. An illumination optical system which illuminates an illumination target surface with light from a light source,
the illumination optical system comprising:
a distribution forming optical system including an optical integrator and configured to form a pupil intensity distribution on an illumination pupil located behind the optical integrator; and
a transmission filter with a transmittance characteristic varying depending upon an angle of incidence of light, which is arranged in an illumination pupil space between an optical element with a power adjacent in front of the illumination pupil and an optical element with a power adjacent behind the illumination pupil and which is arranged at a position of incidence of light to pass through only a partial region of the illumination pupil or light having passed through only a partial region of the illumination pupil.

2. The illumination optical system according to claim 1, wherein the transmission filter has a transmittance characteristic of decreasing the transmittance with increase in the angle of incidence of light.

3. The illumination optical system according to claim 2, wherein the optical integrator includes a unit wavefront division face of a rectangular shape elongated along a predetermined direction, and
wherein the transmission filter includes a pair of transmission filter regions arranged corresponding to a pair of regions spaced in a direction perpendicular to the predetermined direction on both sides of the optical axis of the illumination optical system on the illumination pupil.

4. The illumination optical system according to claim 1, wherein the optical integrator includes a unit wavefront division face of a rectangular shape elongated along a predetermined direction, and
wherein the transmission filter includes a pair of transmission filter regions arranged corresponding to a pair of regions spaced in a direction perpendicular to the predetermined direction on both sides of the optical axis of the illumination optical system on the illumination pupil.

5. The illumination optical system according to claim 4, which is used in combination with a projection optical system to form a surface optically conjugate with the illumination target surface, wherein the illumination pupil is a position optically conjugate with an aperture stop of the projection optical system.

6. The illumination optical system according to claim 4, further comprising a light quantity distribution adjuster to modify an illuminance distribution on the illumination target surface or a shape of an illumination region formed on the illumination target surface.

7. The illumination optical system according to claim 6, wherein the light quantity distribution adjuster corrects an effect of the transmission filter on a light quantity distribution on the illumination target surface.

8. The illumination optical system according to claim 1, which is used in combination with a projection optical system to form a surface optically conjugate with the illumination target surface, wherein the illumination pupil is a position optically conjugate with an aperture stop of the projection optical system.

9. The illumination optical system according to claim 1, further comprising a light quantity distribution adjuster to modify an illuminance distribution on the illumination target surface or a shape of an illumination region formed on the illumination target surface.

10. The illumination optical system according to claim 9, wherein the light quantity distribution adjuster corrects an effect of the transmission filter on a light quantity distribution on the illumination target surface.

11. An exposure apparatus comprising the illumination optical system as set forth in claim 1, for illuminating a predetermined pattern, the exposure apparatus performing exposure of the predetermined pattern on a photosensitive substrate.

12. The exposure apparatus according to claim 11, comprising a projection optical system to form an image of the predetermined pattern on the photosensitive substrate, the exposure apparatus implementing relative movement of the predetermined pattern and the photosensitive substrate along a scanning direction relative to the projection optical system, thereby performing projection exposure of the predetermined pattern on the photosensitive substrate.

13. The exposure apparatus according to claim 12, wherein the predetermined direction in the optical integrator corresponds to a direction perpendicular to the scanning direction.

14. A device manufacturing method comprising:
effecting the exposure of the predetermined pattern on the photosensitive substrate, using the exposure apparatus as set forth in claim 11;
developing the photosensitive substrate on which the predetermined pattern has been transferred, to form a mask layer in a shape corresponding to the predetermined pattern on a surface of the photosensitive substrate; and
processing the surface of the photosensitive substrate through the mask layer.

15. An exposure optical system to perform exposure of an exposure target surface with light from a light source,
the exposure optical system comprising:
a distribution forming optical system including an optical integrator and configured to form a pupil intensity distribution on an illumination pupil located behind the optical integrator; and
a transmission filter with a transmittance characteristic varying depending upon an angle of incidence of light, which is arranged in an illumination pupil space between an optical element with a power adjacent in front of the illumination pupil and an optical element with a power adjacent behind the illumination pupil or a space conjugate with the illumination pupil space and which is arranged at a position of incidence of light to pass through only a partial region of the illumination pupil or light having passed through only a partial region of the illumination pupil.

16. The exposure optical system according to claim 15, wherein the transmission filter has a transmittance characteristic of decreasing the transmittance with increase in the angle of incidence of light.

17. The exposure optical system according to claim 15, wherein the optical integrator includes a unit wavefront division face of a rectangular shape elongated along a predetermined direction, and
wherein the transmission filter includes a pair of transmission filter regions arranged corresponding to a pair of regions spaced in a direction perpendicular to the predetermined direction on both sides of the optical axis of the illumination optical system on the illumination pupil.

18. The exposure optical system according to claim 15, further comprising a projection optical system, arranged between the illumination pupil space and the exposure target surface, including an aperture stop, wherein the illumination pupil is a position optically conjugate with the aperture stop of the projection optical system.

19. The exposure optical system according to claim 15, further comprising a light quantity distribution adjuster to modify an illuminance distribution on the exposure target surface or a shape of an illumination region formed on the exposure target surface.

20. The exposure optical system according to claim 19, wherein the light quantity distribution adjuster corrects an effect of the transmission filter on a light quantity distribution on the exposure target surface.
